(19) United States
(12) Patent Application Publication
(10) Pub. No.: US 2013/0096990 A1
(43) Pub. Date: Apr. 18, 2013

(54) Purchasing Trading Partners Feedback Process for Purchase Practice Refinement

(71) Applicant: S/T Health Group Consulting, Inc., Stafford, TX (US)

(72) Inventors: David Wertz, Sugar Land, TX (US); Richard Tulio, Sugar Land, TX (US); Guy M. Shivitz, Houston, TX (US)

(73) Assignee: S/T HEALTH GROUP CONSULTING, INC., Stafford, TX (US)

(21) Appl. No.: 13/709,766

(22) Filed: Dec. 10, 2012

Related U.S. Application Data
(62) Division of application No. 13/193,869, filed on Jul. 29, 2011.
(60) Provisional application No. 61/454,377, filed on Mar. 18, 2011.

(51) Int. Cl. G06Q 10/06

(52) U.S. Cl. CPC G06Q 10/0637
USPC 705/7.36

(57) ABSTRACT

Systems and methods for refining repetitive purchases using historical feedback and contractual data are disclosed. For example, parties to a pharmaceutical purchase transaction typically include one or more of a Group Purchasing Organization (GPO), vendor or manufacturing drug company, wholesaler, and a purchaser, such as a hospital or hospital group. In a typical pharmaceutical purchase transaction, several (possibly inconsistent) agreements can be in place between the parties to the transaction. Disclosed are methods and systems to collect, from a plurality of data sources, information pertaining to negotiated contract prices of pharmaceutical and surgical supplies. Also disclosed is a periodic process to provide purchasing suggestions and receive further feedback from purchasers and suppliers to refine the activities of the purchaser and/or supplier. For example, a purchaser could be informed of a different order placement option which could result in a cost savings based on currently available pricing/purchase agreements.

### CROSS-REFERENCE TO RELATED APPLICATIONS

This application is a divisional of U.S. patent application Ser. No. 13/193,869, filed 29 Jul. 2011, entitled “Purchasing Trading Partners Feedback Process for Purchase Practice Refinement” and also related to U.S. Provisional Application No. 61/454,377, filed 18 Mar. 2011, entitled “Pharmaceutical Purchasing Trading Partners Feedback Process for Price Verification and Purchase Practice Refinement” each by Wertz et al. and which are incorporated herein by reference in their entirety and to which priority is claimed.

### FIELD OF INVENTION

This disclosure pertains to a method and system for providing a cost improvement feedback process (i.e., feedback loop) between different parties involved in the purchaser/supplier process (purchasing trading partners). For example, purchasers could include entities buying pharmaceutical drugs, surgical supplies, and other health care supplies. The feedback process could be used to potentially reduce purchaser costs or improve stocking practices of suppliers.

### BACKGROUND

Tracking pharmaceutical and other medical supply costs within an organization can be a complex undertaking. Reasons for this complexity include a variety of interrelated contracts, packaging options, incentives, rebates and interaction requirements between multiple parties involved in each transaction.

FIG. 1A illustrates a process flow 100 related to setting up purchasing agreements between parties of a typical medical supply transaction. Initially, at block 102, a group purchasing organization (GPO), identifies purchasing entities for representation. A GPO will typically represent a plurality of individual purchasing entities or groups of related purchasing entities to negotiate a better price (block 105) from one or more vendors. After negotiations are complete and a pricing contract is in place a vendor informs wholesalers and possibly their distributors of contract terms (block 107). The currently negotiated pricing and terms are utilized for purchasing entity purchases (block 109) until another cycle of negotiations and contracts are in place. It should be noted that one GPO may renegotiate at a different periodic cycle from other GPOs and data communication regarding which purchasing entities are covered by certain negotiated pricing contracts can be a complex undertaking.

Some of the complexities of both contract interaction and data communication mentioned above will now be described in more detail and explained with reference to FIG. 1B. Block diagram 110 illustrates a matrix of interaction paths between the four types of parties typically involved in pharmaceutical and other medical supply transactions.

In a typical pharmaceutical purchase transaction, several (possibly inconsistent) agreements can be in place between the parties to the transaction. Parties to a pharmaceutical transaction typically include one or more of a Group Purchasing Organization (GPO) 111, vendor or manufacturing drug company (acting as its own vendor) 120, wholesaler 130, and a purchaser, such as a hospital or hospital group 140. Each of these four parties is involved in product procurement and contractual agreements for the purchase of pharmaceuticals, and each could have a different approach to pricing. Connecting and correlating information from these different disciplines provides the information required as input to determine price accuracy and identify potential billing errors eligible for refund. Further, comprehensive knowledge across these disciplines could provide guidance toward proper purchasing practices at any given time. Each of the agreements between interested parties may be in flux and may change based on a different periodic schedule (e.g., monthly, quarterly, annually, or even every several years). This flux leads to a situation where a purchaser should not necessarily order the same item repeatedly because what may have been an optimal order previously is not currently the best manner to order the same pharmaceutical.

Prior art systems in this field are directed only to determining historical billing errors relating to past purchases. Pricing errors and non-optimal purchasing practices can often be traced to the differences in operation that exist between distributors (which are normally related to wholesalers 130) and manufacturers 120, which affect the integrity of contract prices received by purchasers 140. Drug wholesalers 130 obtain their price data from multiple sources and must synchronize the source data from various systems. Meanwhile, GPOs 111 negotiate contracts on behalf of their many health care provider customers (i.e., purchasers 140). Pricing problems can arise when the manufacturers 120, GPOs 111, purchasers 140, and wholesalers 130 have different active information about the correct contract price. Another point of contention is timing (i.e., when the contractual agreement and specific price take effect). Compounding the pricing model further, the eligibility of certain facilities to receive a specific price may have an effect as determined by the type of practice, types of patients served, and various legal aspects relating to class of trade. For example, all parties must agree on how a facility will be categorized (e.g., as an ambulatory care clinic), because some manufacturers offer different prices to different classes of trade.

The contracting process explained above with reference to FIG. 1A can be supported by a communication flow as outlined in FIG. 1B. After a contract is in place, GPO 111 offers a product line to its membership (as depicted by bidirectional relationship 116). Additionally, in some cases, solicitation occurs directly between a manufacturer and a hospital group or individual health care provider (purchaser) 140. Once two parties reach an agreement (as depicted by bidirectional relationship 112 or 124), information pertinent to that agreement is communicated to wholesaler 130 (114, 122, and/or 135). Wholesalers 130 can then load information into its database and enable specific purchasers 140 to purchase the contracted products at the contract price.

Contracts between GPO 111 and manufacturer 120 usually identify the term of price protection and any limit on price increases outlined by the agreement. In some cases, price protection could extend for the entire life of the contract. In other cases, the contract may offer no price protection. There may be firm price limits, often expressed as an annual price increase cap, or no price limits at all. Usually, these factors vary from contract to contract (even between multiple contracts involving the same two parties). A manufacturer may seek to increase/decrease product prices for a multitude of business reasons (e.g., costs, competition, and volume purchases). When a price is changed, the changed pricing information must be communicated (112, 122, 124) to wholesalers 130, purchasers 140 and GPOs 111. Synchronization is important to ensure a customer pays the negotiated prices as reflected in the wholesaler 130 and GPO 111 databases. However, synchronization errors or timing delays, either in data transmittal or effective date of new price, can be a contributing source to billing errors and to non-optimal/non-compliant purchasing. As explained further below, non-optimal purchasing includes purchases that are on contract but may not be a best priced purchase method and non-compliant purchasing includes purchases that were made outside of an existing price reduction contract (i.e., “off-contract”).

There are several different types of pricing models for pharmaceutical purchasing. Examples include: fixed manufacturer, discounted manufacturer, and rebates. Details of each pricing model are known to those of ordinary skill in the art and may change over time. Actual details of these specific pricing models are not discussed further, but the concepts of this disclosure could be applied to these or other pricing models. Similarly, there are several types of pharmaceutical agreements (e.g., wholesaler supply agreements, participation agreements, tiered contracts, individual contracts, etc.). Details of each type of agreement are not discussed further because the concepts of this disclosure could be applied to purchases based on any type of agreement.

Unrelated to any specific type of contract or purchasing agreement, there exist other complexities concerning pharmaceutical purchases. One such complexity stems from the fact that similar or identical drugs may be available in either brand name or generic brand(s) as well as for purchase in different quantities, packaging styles, or administering methods. For example, a purchaser 140 may need to order ibuprofen. There are many different strengths, quantities, and styles of ibuprofen. For example, there are 50 mg tablets packaged in quantities of 10 or 100 per package; oral solutions of different strength or flavors; and many other different packaging options or administration styles that may or may not be important for a given order. Additionally, doctors and surgeons may have personal preferences or specific medical reasons why a particular type of pharmaceutical or surgical supply should be purchased. Sometimes these “preferences” are strict (e.g., because of actual medical reason) and sometimes these “preferences” have factors that should be weighed because the rationale behind the preference is less important (e.g., doctor personal preference). As should now be apparent, each of these and other factors, in addition to price contract complexity, make it difficult for a purchaser 140 to make an optimal purchasing decision at time of order placement.

As explained above, prior art techniques exist to historically analyze actual purchases against contracts in place at the time of purchase; however, prior art techniques do not utilize a feedback loop to refine purchase recommendations. Prior art techniques offer a “one-time-period” analysis as opposed to a continual refinement process. Therefore, what is needed is a system and method to normalize data (e.g., determine a unitized cost) of pharmaceuticals and to use the normalized data and existing contract information in a feedback loop to identify possible purchasing alternatives possibly resulting in reduced costs. The feedback loop can utilize purchase information and analysis of non-compliant/non-optimal purchases from previous buying periods to affect suggested purchasing alternatives in current or future buying periods. Additionally, the feedback loop could provide information to wholesalers and their distributors regarding potential changes in stocking practices to accommodate purchasing entities supplied by one or more distribution centers.

### BRIEF DESCRIPTION OF THE DRAWINGS

FIGS. 1A-B illustrate, in flow chart and block diagram form respectively, an example of parties to pharmaceutical and surgical supply purchasing and their interactions in the contracting, purchasing and data exchange process.

FIGS. 2A-B illustrate a flow chart 200 depicting a periodic monitoring process of pharmaceutical and surgical supply purchasing and feedback loop according to one disclosed embodiment.

FIG. 3 illustrates a contract compliance conversion report, presented at a corporate level (e.g., a consolidated roll-up of purchases across all hospitals in a hospital group).

FIGS. 4A-C illustrate a contract compliance report (with feedback fields) for a particular purchasing entity (i.e., Santo Domingo Community Hospital) representing detail at a lower level than FIG. 3.

FIGS. 5-7 illustrate different views of corporate level and purchasing entity level information indicating potential savings available through altered purchasing practices according to a disclosed embodiment.

FIGS. 8-9 illustrate reports, at a corporate and regional level, reflecting how purchasing entities responded to identified optimization of purchases for the current reporting period.

FIGS. 10-11 illustrate reports, at purchasing entity level and a regional level, reflecting feedback information from purchasing entities according to a disclosed embodiment.

FIG. 12 illustrates a reply report suitable for feedback loop processing at a corporate level relative to information received from purchasing entities in one periodic cycle of a feedback loop according to a disclosed embodiment.

FIG. 13 illustrates a report identifying purchases which a purchasing entity has asserted were on manufacturer back order during a reporting period, however, other purchasing entities successfully ordered an identical purchase within the same reporting period.

FIG. 14 illustrates a report of potential savings if vendors or distributors and their distribution centers would adapt stocking practices, the report including an indication as to how to adapt stocking practices.

FIG. 15 illustrates, in flow chart form, an embodiment of more detailed flow steps, according to one embodiment, for FIG. 2 blocks 265-275.

FIG. 16 illustrates, in block diagram form, an example computing device comprising a program control device.

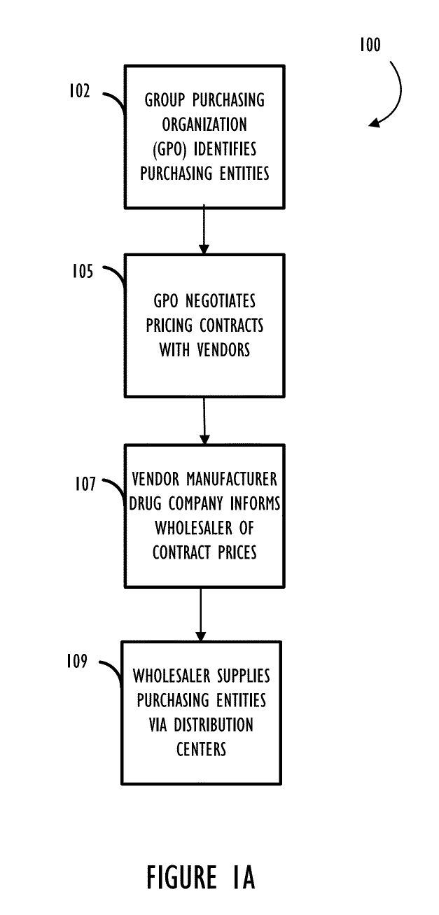

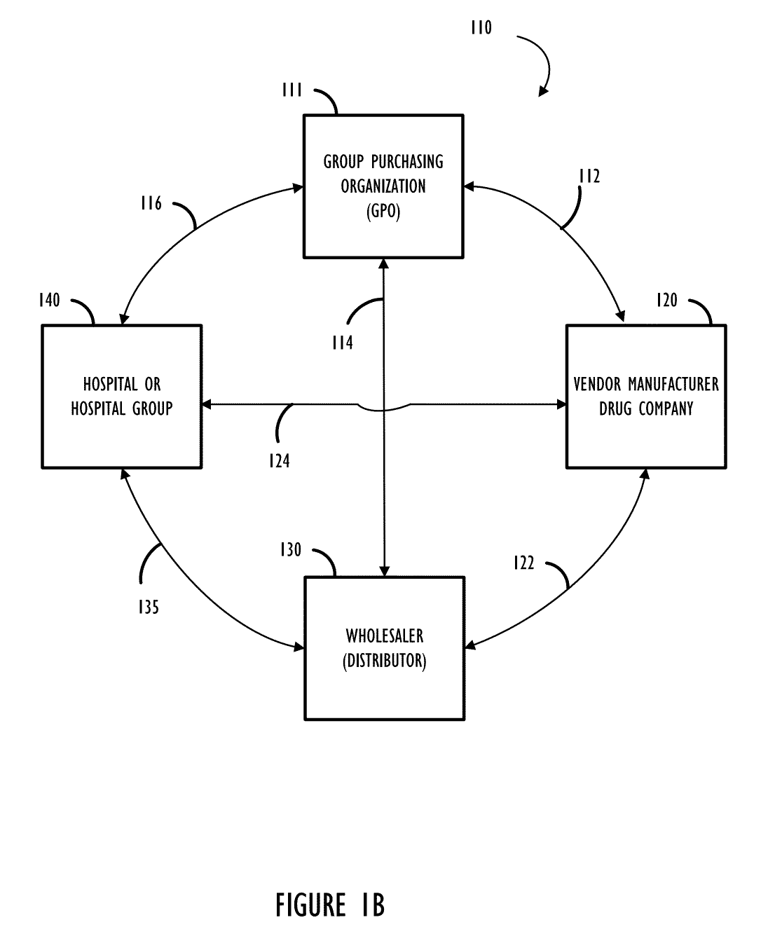

### DETAILED DESCRIPTION

The present disclosure is described in the context of pharmaceutical drug purchases. However, concepts of this disclosure could relate to any purchases covered by a plurality of purchasing contracts or methods at a given point in time. For example, transactions consisting of: pharmaceuticals, medical supplies, surgical supplies, laboratory supplies and services (e.g., outsourced laboratory services), radiological supplies, and/or other health care consumables, or transactions comprising a combination of one or more of these, etc. Additionally, electrical supply, automotive supply, and hardware supply items have similar supply chains and alternate item purchase properties (i.e., Original Equipment Manufacturer (OEM) vs. alternative equivalent) and should not be considered outside the scope of this disclosure.

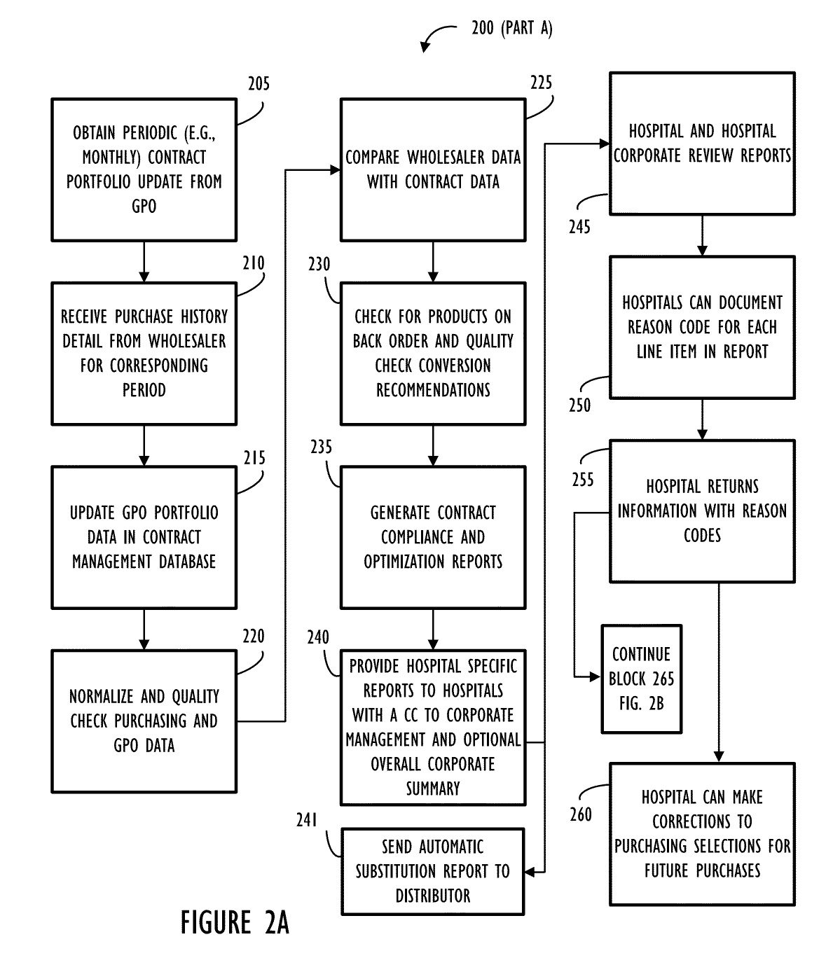

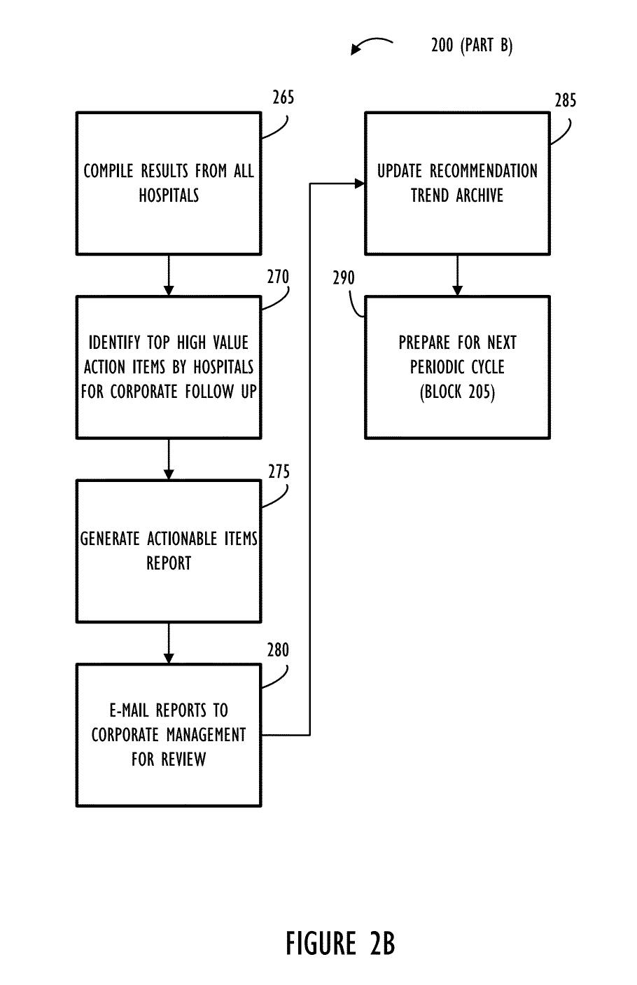

With reference to FIGS. 2A-B, a process flow of a general feedback loop according to a disclosed embodiment will first be described and then more detail about particular portions of the feedback loop will be described with reference to example information reports. A feedback loop according to a preferred embodiment could take place at a monitoring center “external” to any of the parties directly involved in the purchasing process. The monitoring center of this embodiment would provide a service to one or more of a GPO 111, Manufacturer 120, Wholesaler 130 or Purchasing Entity 140. The service provider would be communicatively coupled for automatic data exchange between one or more of these parties. Additionally, the service would normally be of most benefit to a purchasing entity 140 and is therefore described in that context (i.e., a service provided to a purchasing entity 140 from an external party) for several embodiments of this disclosure.

Referring now to FIGS. 2A-B, process 200 illustrates a periodic process of monitoring purchases over a given time period; providing information regarding specific purchases which appear to be non-optimal; receiving feedback, from a purchasing entity 140, regarding non-optimal purchases; and providing information to corporate management and possibly manufacturers/distributors (120/130) regarding potential changes in business practices to reduce future costs to purchasing entities 140. The periodic feedback loop of this disclosure will be described in the context of a monthly review provided by an external service provider; however any particular time period or an internal operational environment may be suitable for the concepts disclosed.

Beginning at block 205, current contract information applicable to a particular purchasing entity 140 can be periodically obtained from a GPO 111. Next, at block 210 a purchase history for a corresponding period may be obtained from a wholesaler 130 or other suppliers to the purchasing entity 140 being analyzed. Information regarding contract portfolio data can be collected and correlated in a management database (215), normalized as necessary to a unit comparison price and quality checked for any recognizable errors (220). After quality assurance and normalization, purchase data can be compared with applicable contract data (225). Next, at block 230, conversion recommendations (representing possible alternate purchases) can be computed, quality checked, and product back order status (may be cause of non-optimal purchase) can be determined. After accurate input data for a period has been collected, flow can continue to block 235 to generate a contract compliance and optimization report for a particular purchasing entity 140. Contract compliance and optimization reports indicate information specific to a particular purchasing entity 140 (e.g., hospital) and composite information about non-optimal purchasing by hospitals in a hospital group (e.g., corporate or regional level) can be correlated into reports which may later be used to provide initial information (block 240) and receive further information for later use in the feedback loop. Additionally, a report (block 241), based on content similar to the content sent to the purchasing entity 140, could be automatically sent to a distributor 130 to define automatic substitution of items purchased with recommended alternative purchases.

At block 245, individual purchasing entities 140 and corporate level management can review applicable reports. Each purchasing entity 140 can document a reason code for each line item in their report to explain a reason for the non-compliant purchase (250). Based on the periodicity, purchasing entities 140 have a time period to analyze and document their individual reports and should return completed reports with reason codes (255) within the allowed time period. Immediately upon receipt of a detail report, a purchasing entity 140 can alter their internal purchasing practices (260) so that current period purchases do not again show as non-optimal in the next reporting period.

At block 265 of FIG. 2B, a secondary phase of feedback loop 200 begins with a compilation of all completed reports for further analysis and generation of other corporate and regional level reports. High value action items, either for individual purchasing entities 140 or for action from a corporate level, can be identified (270). A corporate level action item report can be generated (275) and sent to corporate management for review and action (280). Finally, responses from purchasing entities 140 concerning non-optimal/non-compliant purchases can be analyzed and, if applicable, utilized to update a recommendation trend archive to possibly prevent future non-applicable recommendations. For example, if a purchasing entity 140 reports a valid reason for a non-optimal/non-compliant purchase, the trend database could be used to prevent future flagging of identical purchases from showing up as non-optimal/non-compliant purchases. Feedback loop processing can then begin a next periodic cycle as indicated at block 290.

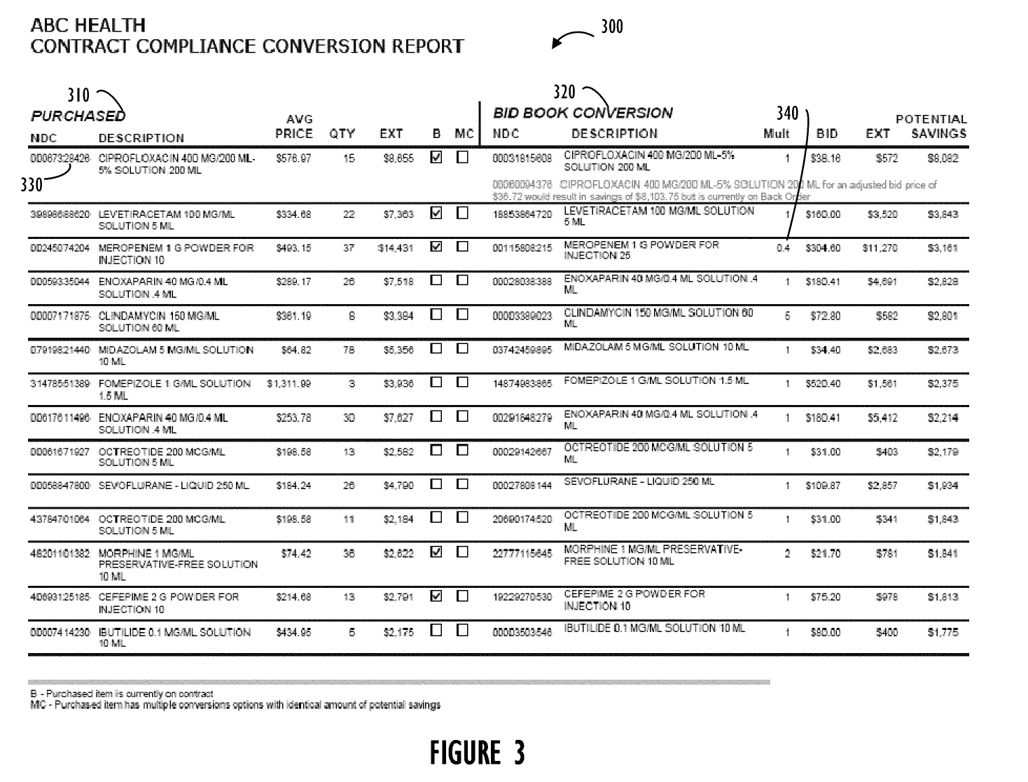

Referring now to FIG. 3, a corporate (e.g., “ABC Health”) level “Contract Compliance Conversion Report” 300 is shown. In this example, ABC Health represents a hospital group (e.g., corporate) with a plurality of purchasing entities 140. The report reflects line items of individual items purchased across an entire corporation in a reporting period. The left portion of the report PURCHASED 310, lists, by National Drug Code (NDC) number, items actually purchased in one or more purchasing entities 140 of ABC Health. The right portion of the report “BID BOOK CONVERSION” (“BBC”) 320, lists, also by NDC number, items under contract which may represent a more cost effective purchase opportunity. In the PURCHASED 310 portion there are also columns for description, average price, quantity purchased, extended price, column “B,” and column “MC.” BBC 320 portion has columns for NDC, description, multiplier, BID, extended price for BID, and potential savings. Although report 300 keys purchases to an NDC, many other unique product identifiers could be used to key this type of report. For example, Universal Product Code (UPC) numbers and barcode numbers along with other product identification numbers could be used.

One purpose of report 300 is to indicate, for each actual purchase, a corresponding purchase (or possible purchase for consideration) which was available, under contract, believed to be medically equivalent and would have cost less for the purchasing entity 140. For example, the first item (line 330) identifies an alternative NDC for CIPROFLOXACIN which would have resulted in a savings of $8,082 for ABC Health even though the item(s) actually purchased was under contract (contract indicated by check mark in column B). Looking further at line 330 notice that a quantity of 15 CIPROFLAXCINs were purchased and the average price paid for these 15 purchases was $576.97 for a total cost of $8,655. The BBC portion of line 330 identifies two potential alternative purchases (one believed to be available and another which may be on back order) and the savings associated with the alternative purchasing method. A multiplier of 1 indicates no adjustments must be made for different packaging configurations between the actually purchased NDC and the suggested NDC. In this example, there simply appears to be a much better alternative purchase that could have been made by one or more purchasing entities 140 of ABC Health.

The BID column of the BBC portion of line 330 represents a normalized price at a unit level as adjusted by a multiplier. As stated above, the multiplier for line 330 is 1 and therefore there is no adjustment currently applied for this particular item. However, 340 indicates a multiplier of 0.4 which indicates a packaging difference (250% more) must be accounted for when calculating the BID. The multiplier is calculated by taking into account the fact that the actual NDC purchased comes in a quantity of ten (10) whereas the recommended purchase item comes in a quantity of twenty five (25). To calculate an accurate per unit price we must multiply the actual price of the recommended NDC by 0.40 ( 10/25) to calculate a proper BID price. After a proper BID price is calculated it can be multiplied by the actual quantity purchased (37 in this case) to determine a cost for comparison and estimation of potential savings.

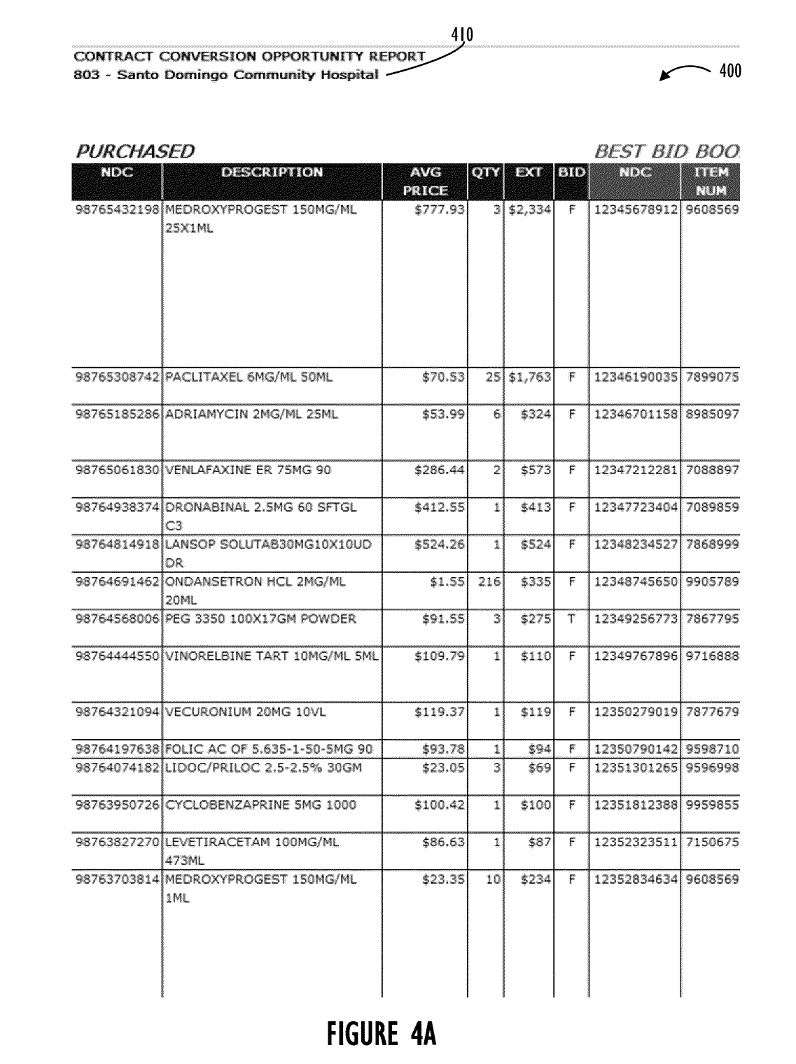

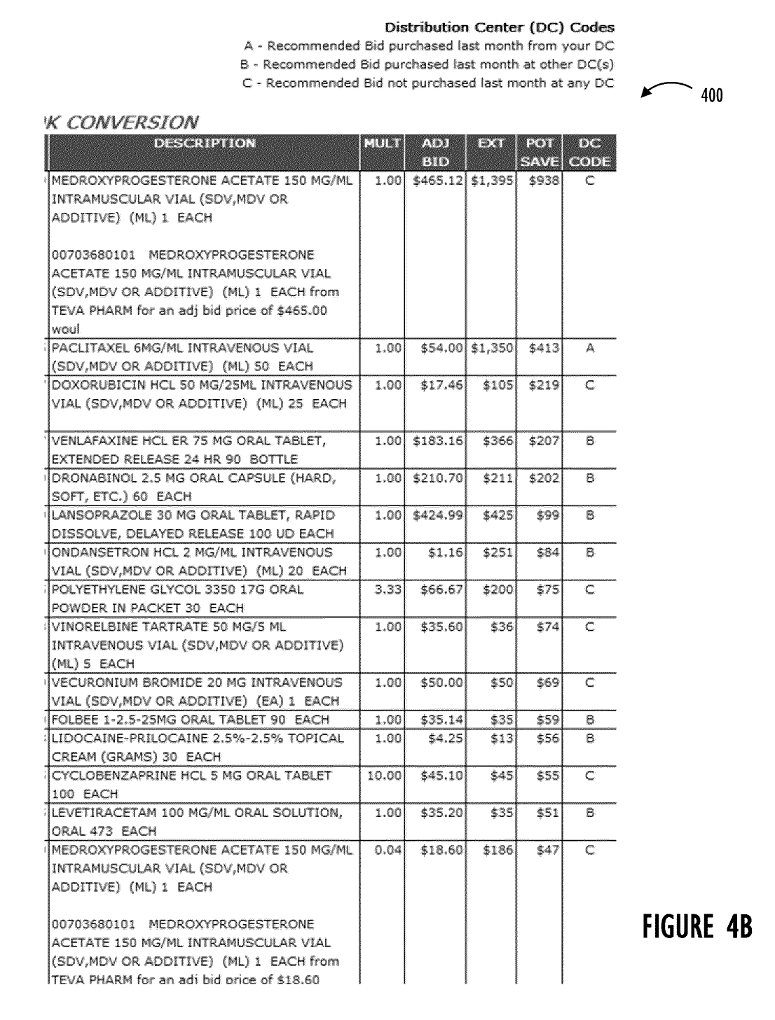

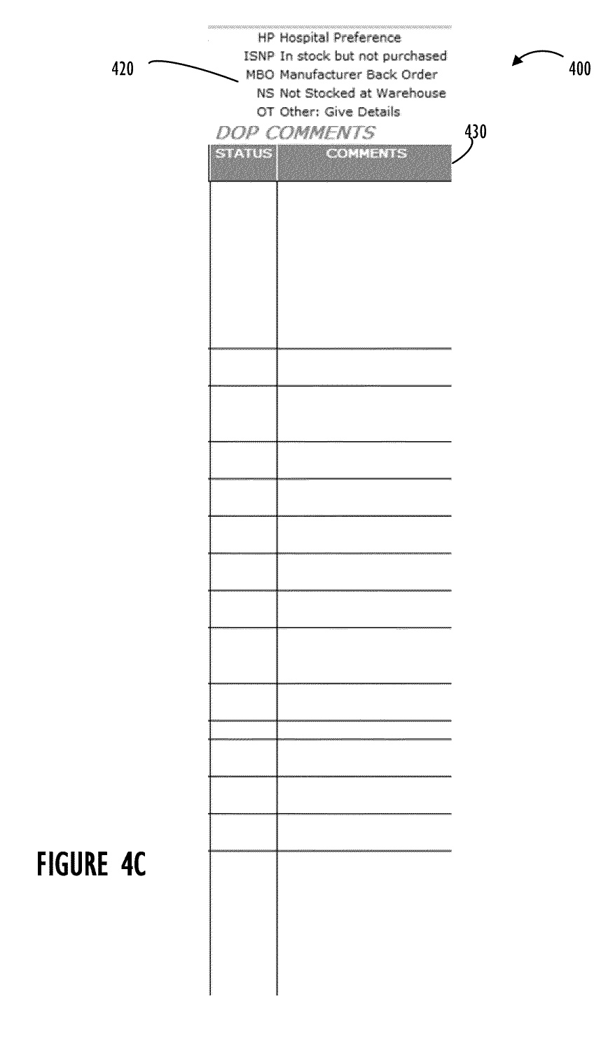

Referring now to FIGS. 4A-C, report 400 shows an example of a “Contract Conversion Opportunity Report” at an individual purchasing entity 140 level. Report 400 is split into a left (4A) center (4B) and right (4C) portion for readability. In this example, the purchasing entity 140 is identified as Santo Domingo Community Hospital as shown by line 410. As mentioned previously, a report is sent to each individual purchasing entity 140 detailing identified non-optimal purchases. Report 400 is an example of information contained in such a report. In addition, to facilitate an automated feedback loop, an electronic report containing data entry fields (such as those shown in FIG. 4C) to explain non-optimal purchases could be sent to each purchasing entity 140. Reason codes (420) and explanations (430) (examples are discussed below) could allow for enhanced management oversight of individual purchasing entities 140 as well as further refinement of data for future feedback reports.

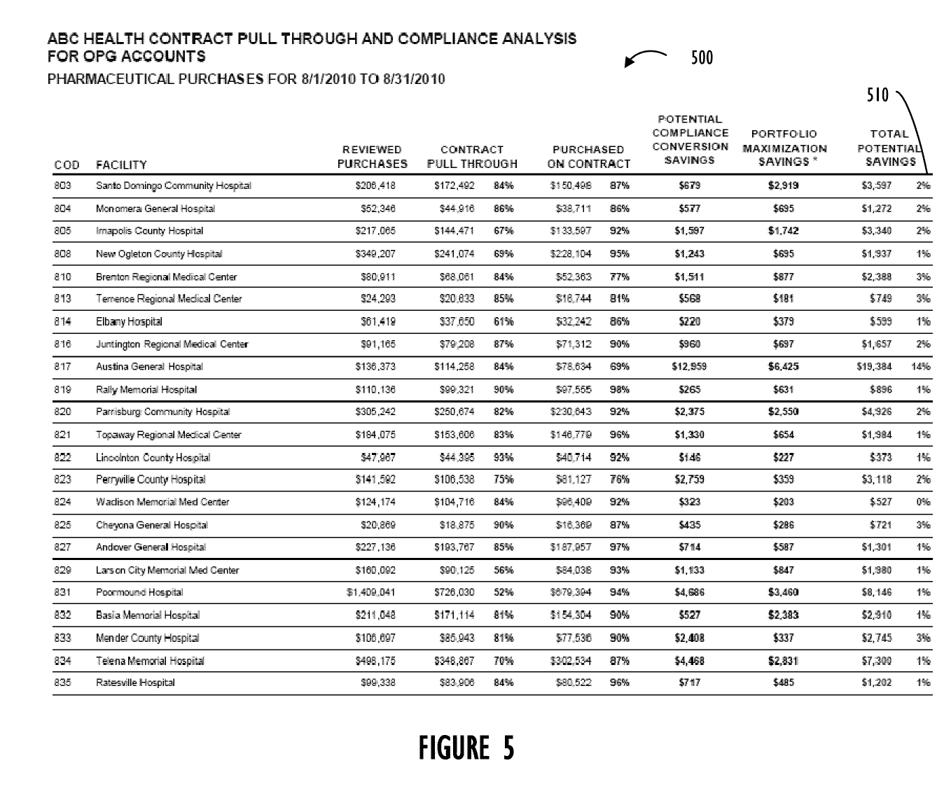

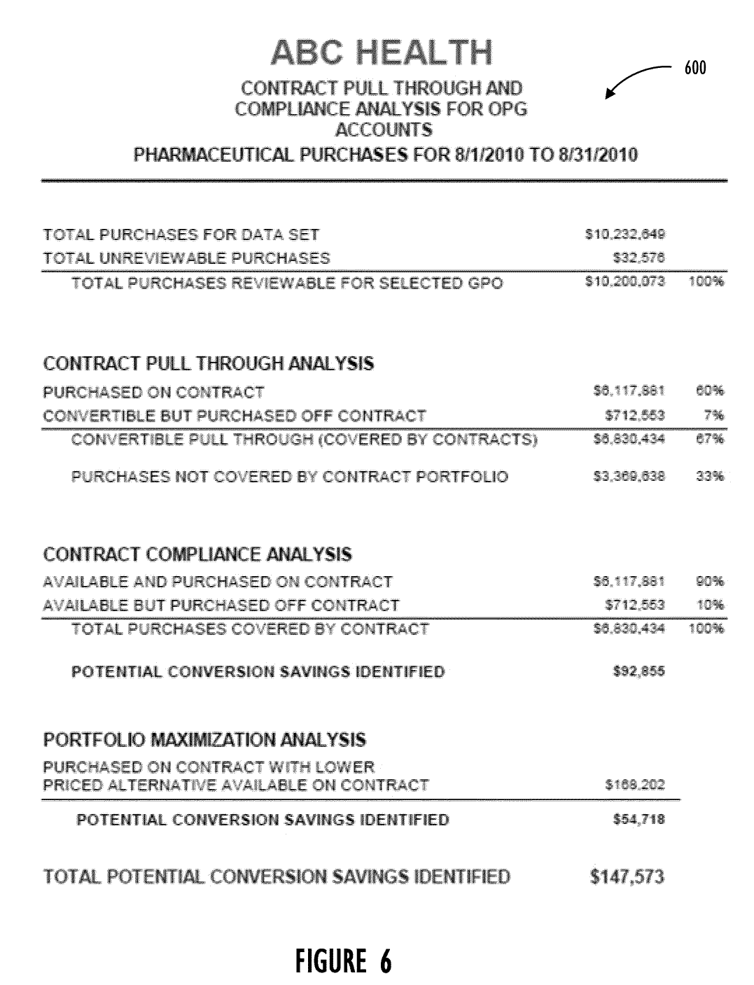

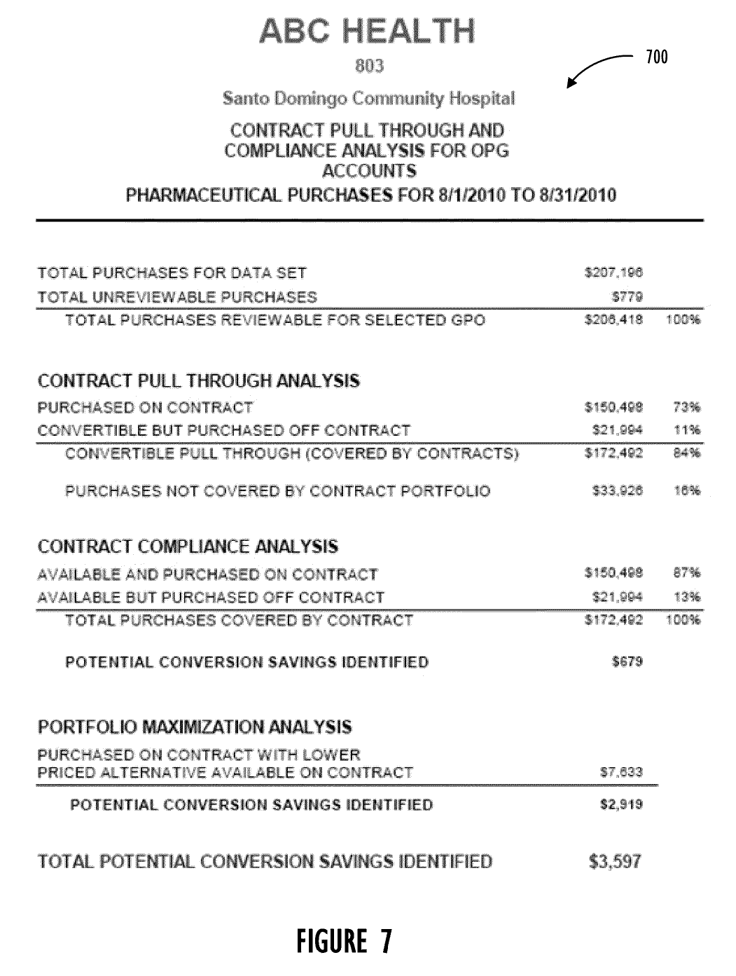

Referring now to FIGS. 5-7, different presentation levels of corporate summary reports (500, 600) and an example purchasing entity 140 summary report (700) are shown. Report 500 illustrates a tabular view of a plurality of purchasing entities 140 with a summary of information for each purchasing entity 140 along with an indication of the percentage 510 of overall potential savings allocated to that particular purchasing entity 140. From a corporate perspective, report 500 could be used to identify which purchasing entities 140 need attention. Report 600 illustrates a single page rollup of all purchases in a reporting period for ABC Health.

As indicated in report 600, ABC Health could have saved $92,855 in “Potential Conversion Savings” if each of the purchases made with no contract (i.e., “off contract”) were replaced with purchases of pharmaceuticals currently on contract. As stated above, details of each non-compliant purchase are identified and summarized at the purchasing entity 140 level in corresponding reporting period reports (e.g., reports 400 and 500). Further, report 600 indicates ABC Health could have saved an additional $54,718 for purchases that were already on contract but were purchased utilizing a different NDC number also already on contract. In summary, ABC Health (at a corporate level) could have saved $147,573 if purchases had been made differently during this reporting period. Additionally, report 700 illustrates a single purchasing entity's 140 (i.e., Santo Domingo Community Hospital) corresponding data related to the information presented in corporate level report 600.

Having the information of reports such as 400-700, each purchasing entity 140 of ABC Health can alter their purchasing practices for the next period (i.e., current purchases) and eliminate repetition of non-optimal purchases. As will be apparent to those of ordinary skill in the art, an optimal feedback loop may be implemented at different frequencies and altering of actual purchasing practices by purchasing entities 140 may have some inherent delay. Additionally, optimal purchases may change over time, at least in part, because contracts and other data underlying the purchase analysis change. Therefore, a continuous and cyclical feedback loop with potentially varied periods may be desirable.

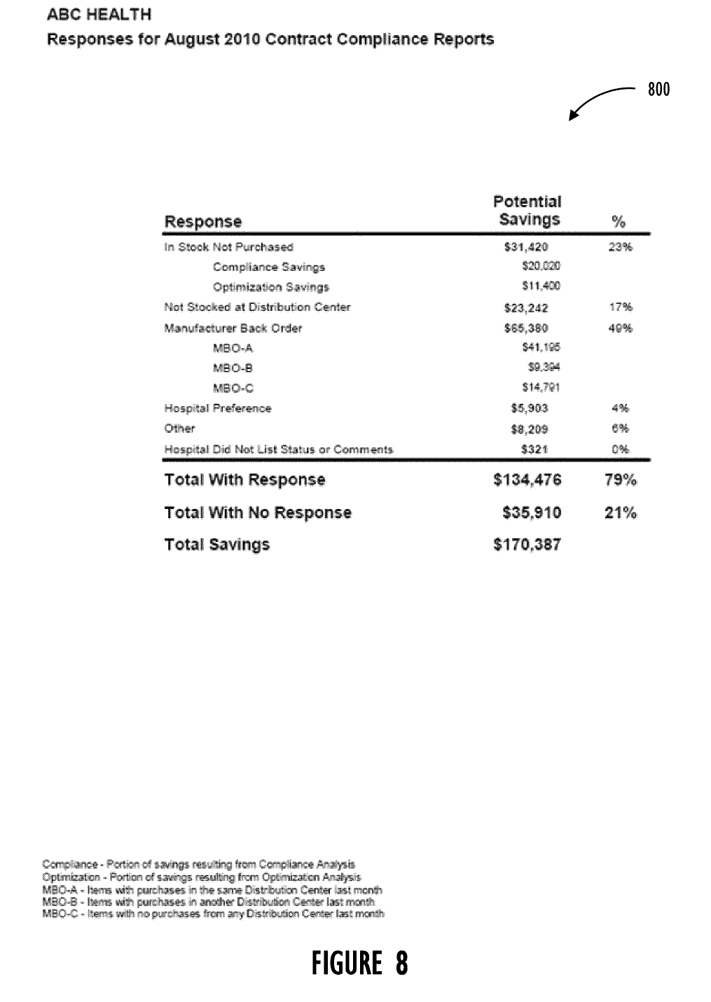

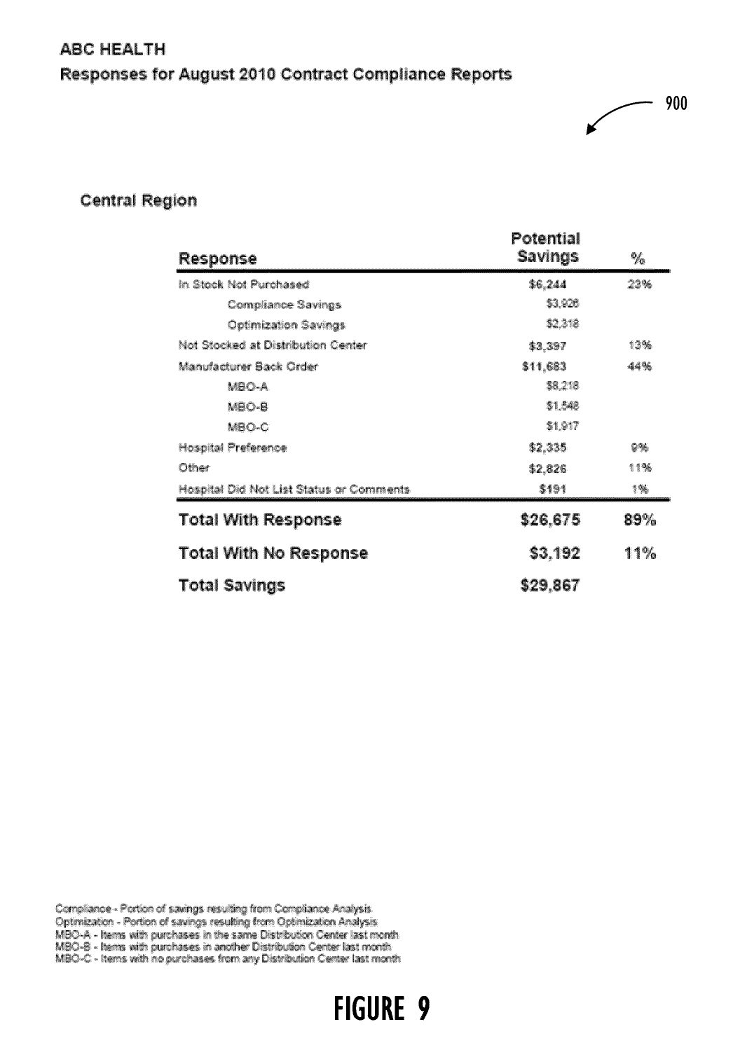

Referring now to FIGS. 8-9, reports 800 and 900 illustrate, at a corporate and regional level respectively, a summarization of response types (explaining non-optimal purchases) from purchasing entities 140 for the current reporting period. Reports 800-900 are examples of “actionable items” reports which could be generated at block 275 of process 200. Each of reports 800 and 900 identify “In Stock Not Purchased” (ISNP) items indicating a purchasing entity 140 has determined they simply made an incorrect purchase and presumably will alter the purchase practice for corresponding items going forward.

Report 800 also breaks down percentages of ISNP items into subparts of “Compliance Savings” (indicating future purchases should be on contract) and “Optimization Savings” (indicating another on contract item should be purchased going forward). Additionally, report 800 classifies purchasing entity 140 responses for each response in which a purchasing entity 140 asserted the reason for a non-optimal purchase was a MBO (i.e., Manufacturer Back Order). Classification codes for a distribution center 130 (DC Codes) include type A, type B and type C. Type A indicates that another purchasing entity 140 purchased the exact same NDC at the same distribution center 130 during the same reporting period. Type B indicates that another purchasing entity 140 purchased the exact same NDC at a different distribution center 130 during the same reporting period. Type C indicates that no purchases of the exact same item were made at any distribution center 130 during the same reporting period. Obviously, Type C supports an indication that the item was in fact on MBO as reported. However, Types A and B indicate that the item may not have really been on MBO as reported.

Both of reports 800 and 900 identify items not stocked at a distribution center 130. This information identifies a potential savings that may be realized by ABC Health and may be useful to encourage change in the manner in which a distribution center 130 stocks its products. Also, both of reports 800 and 900 identify a percentage of purchases that were non-optimal because of a “Hospital Preference” which will be discussed further below. Finally, each of reports 800 and 900 indicate a percentage of non-compliant purchases which were reported to purchasing entities 140 but for which no explanation was provided (i.e., HDNR Hospital Did Not Respond).

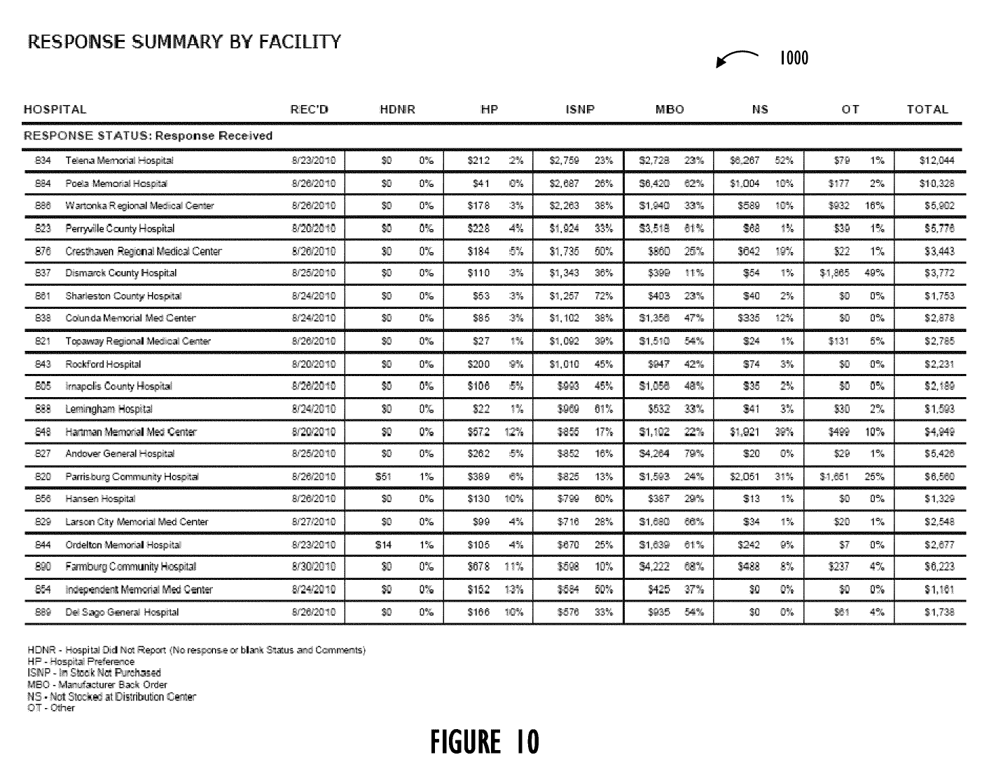

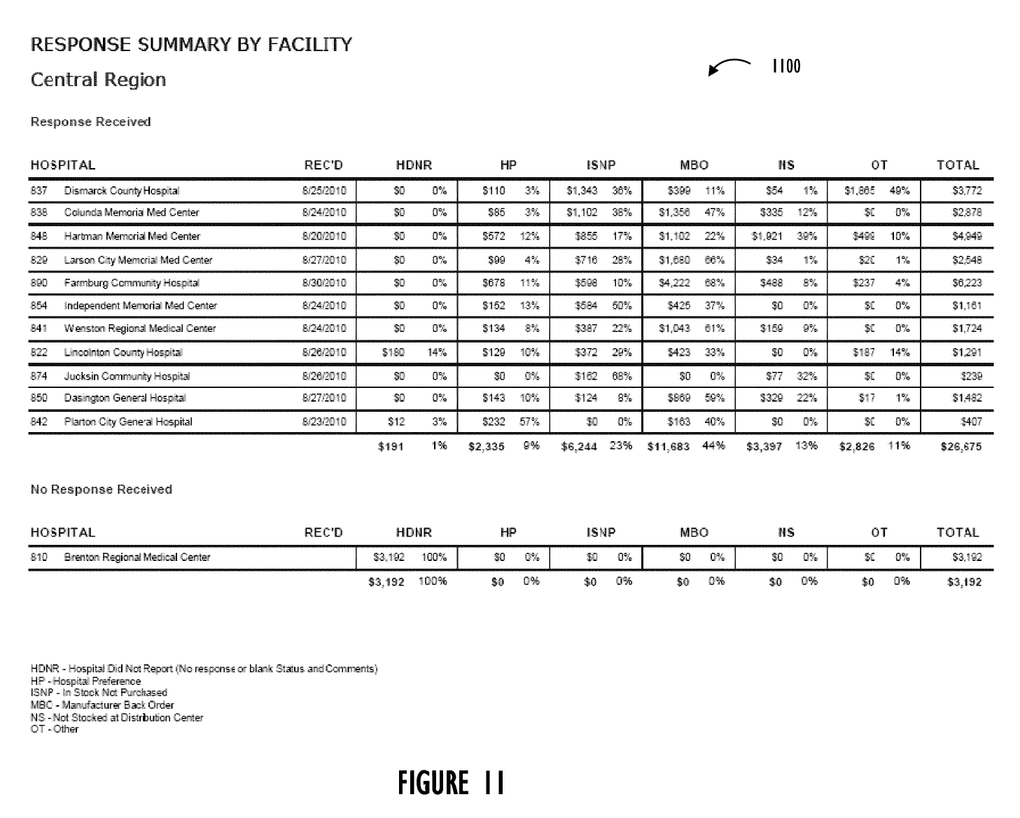

Referring now to FIGS. 10-11, report 1000 corresponds to report 800 however, information here is reported at a regional level (i.e., Central Region). Information reports at this level may be useful in implementing a feedback loop according to disclosed embodiments because a large corporation of hospitals may have regional management which may be able to more effectively utilize specific information. Report 1100 corresponds to a corporate wide view of information explained above relative to report 900. Again, providing (possibly redundant) information at different granularities could provide necessary information to optimize embodiments of a purchasing feedback loop.

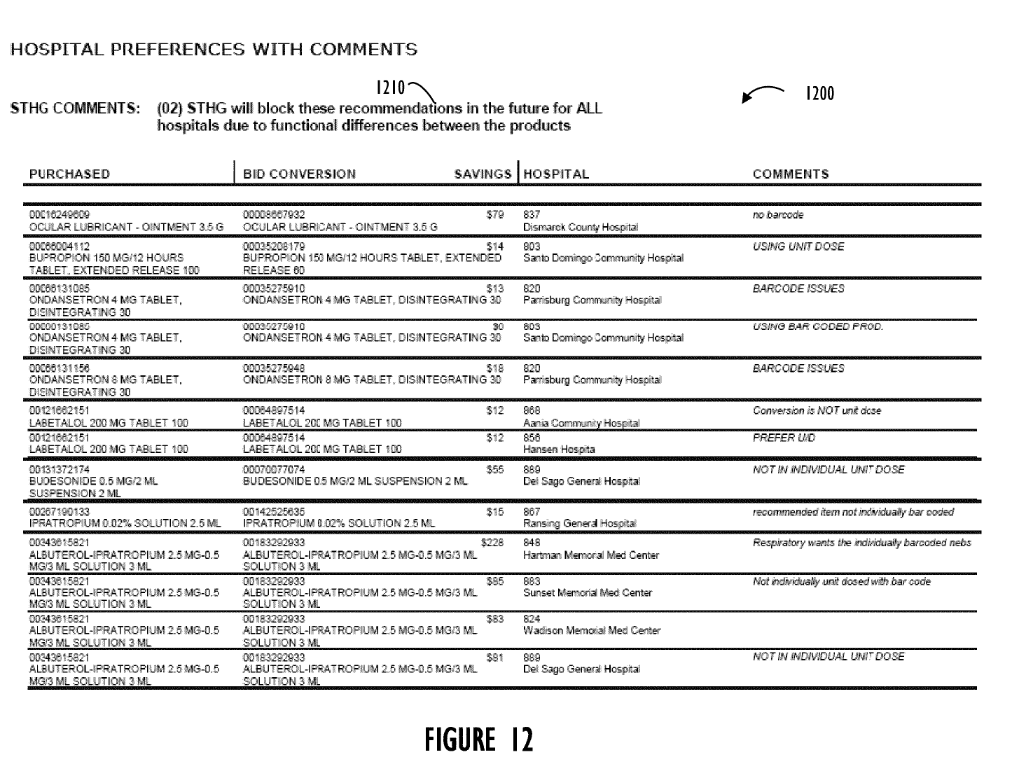

Referring now to FIG. 12, report 1200 illustrates line item responses (for each non-compliant/non-optimal purchase) from purchasing entities 140 received in response to reports such as report 400. Each line item response has been analyzed after receipt and categorized and grouped based on this analysis. Analysis typically includes comparison against responses received for the same reporting period from other purchasing entities 140 to identify potentially inaccurate explanations for non-optimal or non-compliant purchases. As shown in report 1200 at line 1210, a set of responses may be categorized as reasonable and used as an indication to suppress future identification of purchases of the same item as non-compliant. Suppression of this future identification can be used to prevent unnecessary repetitive action by any purchasing entities 140 in future reporting periods. For example, a purchasing entity's 140 response could indicate that a functional or clinical difference may exist between the purchased product and the suggested product. Once verified, this difference is an indication to no longer suggest that same product as an alternative product for any purchasing entity 140. Additional categories could include, but not be limited to: reasonable for a particular purchasing entity 140 and only suppressed for that purchasing entity 140 in the future; comments not provided by purchasing entity 140 so no action taken; comments provided by purchasing entity 140 that may require additional follow up because supplied comments are questionable. Categorized report 1200 could be provided to a corporate or regional manager to identify actionable items for particular purchasing entities 140.

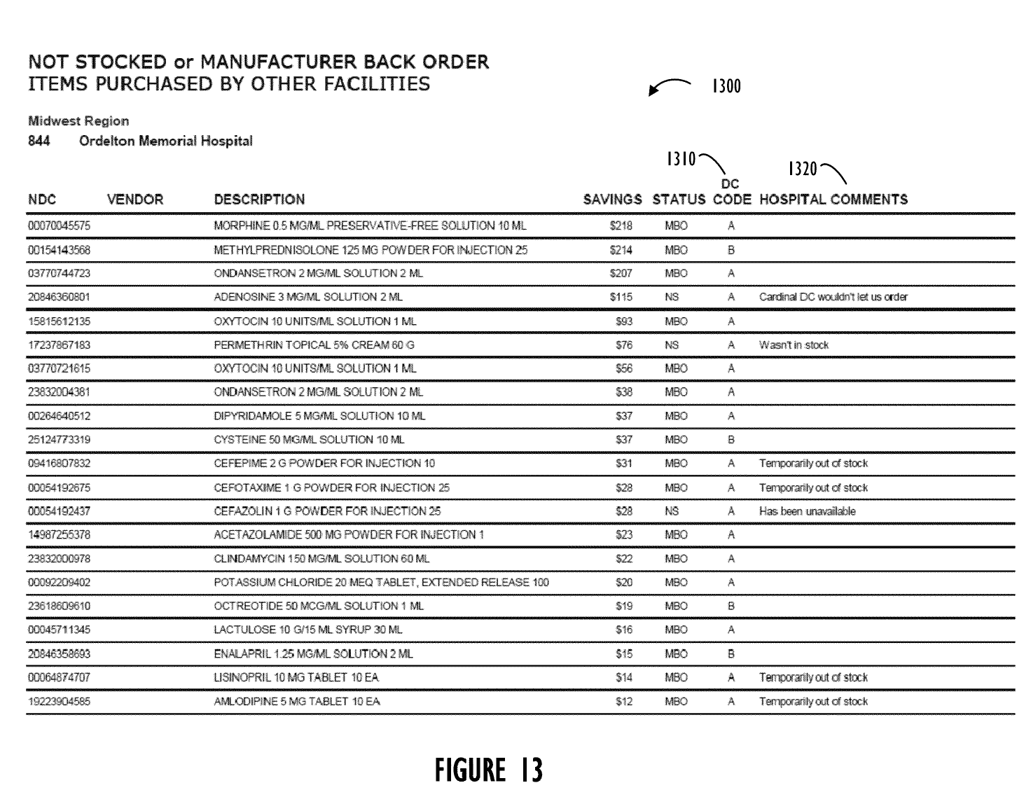

Referring now to FIG. 13, report 1300 illustrates items which were either not stocked at a distribution center 130 or may not have actually been on MBO status (as was reported by a purchasing entity 140) during the reporting period being analyzed. Report 1300 therefore indicates actionable items from a supervisory level to potentially request adjustment of stocking procedures or to determine if explanations provided by purchasing entities 140 were accurate. Note DC CODE 1310 (already explained above) and HOSPITAL COMMENTS 1320 provide further information to help in this determination.

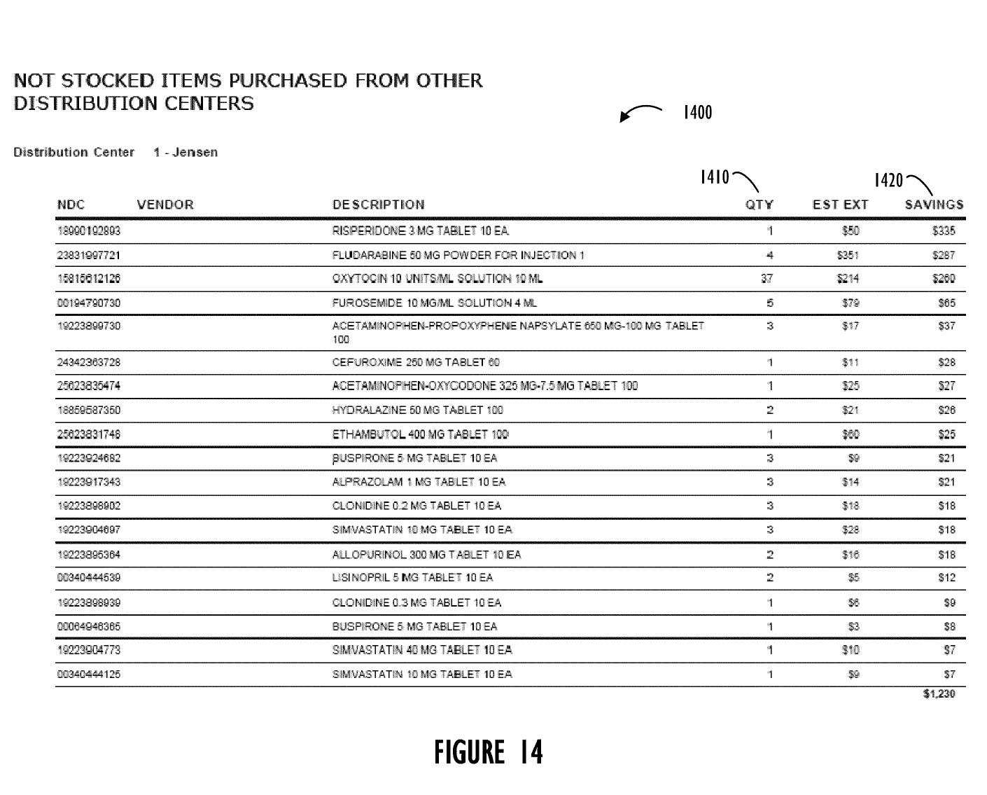

Referring now to FIG. 14, report 1400 illustrates (per distribution center 130) items that were not in stock at a distribution center 130 but were purchased from other distribution centers 130 in the same reporting period. Report 1400 could be used by corporate management to provide information to wholesalers and distribution centers 130 as to how they might alter their stocking procedures in the future. Report 1400 further indicates a suggested stocking amount 1410 for each particular distribution center 130 using historical purchasing information. Additionally, report 1400 indicates potential savings at a corporate level 1420 if a distribution center 130 is convinced and agrees to alter their stocking practices.

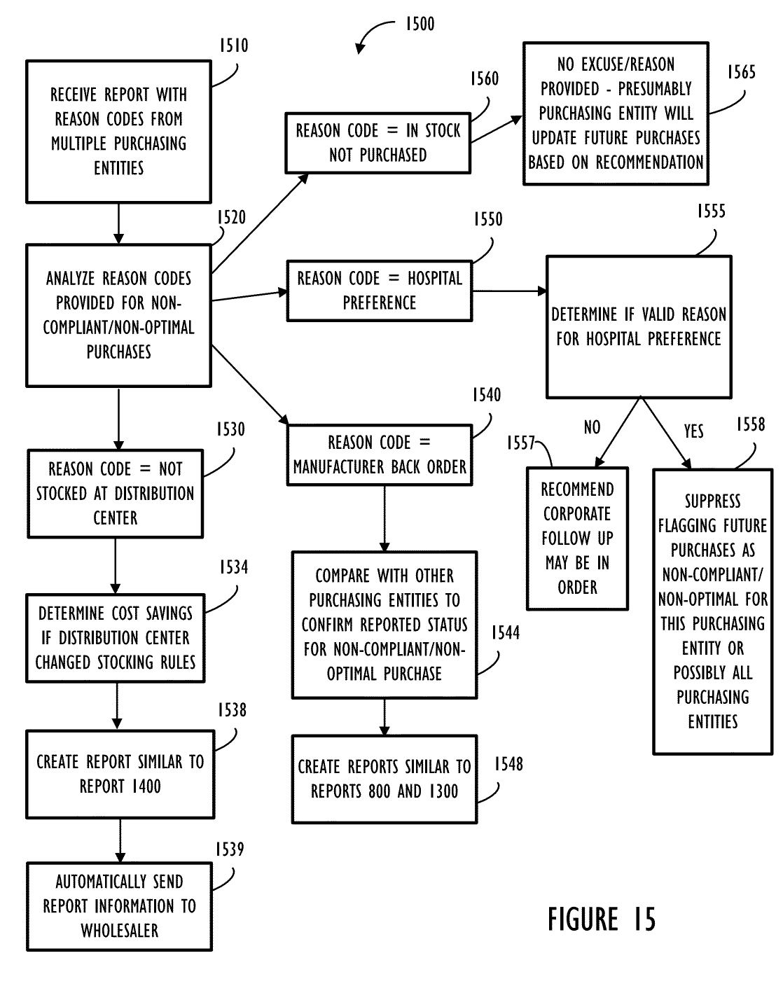

Referring now to FIG. 15, flow chart 1500 illustrates one possible embodiment of blocks 265-275 of FIG. 2. Beginning at block 1510, a processing center practicing one or more disclosed embodiments receives a completed feedback report from one or more purchasing entities 140. At block 1520 the received report is analyzed and responses can be grouped by reason code for further analysis. When the reason code reported by the purchasing entity 140 is “not stocked at distribution center” (block 1530), a potential cost saving across one or more purchasing entities 140 in a group of related purchasing entities 140 can be determined (block 1534) and reported to centralized management for the group of related purchasing entities 140 (block 1538) to possibly recommend to the distribution center 130 a change in stocking rules and/or practices. The stocking changes requested could also indicate a predicted quantity for stocking based upon historical needs across purchasing entities 140 utilizing a particular distribution center 130. A report identifying potential stocking changes could be automatically sent to a wholesaler 130 to alter stocking practices at distribution centers 130 (block 1539).

Continuing with process 1500, when the reported reason code is “manufacturer back order” (MBO) as in block 1540, a plurality of completed reports from different purchasing entities 140 for a corresponding purchasing period can be compared to determine possible inconsistent reports of MBO (block 1544). A summary report can be prepared (block 1548) with different DC codes like A, B, and C explained above. When the reported reason code indicates “hospital preference” a comment field provided in the report and completed to explain the reported preference can be further checked to determine a course of action (block 1550). If the comment does not indicate a reasonable or valid reason (NO branch from block 1555) flow can continue to block 1557 to recommend a possible corporate follow up. However, if the comment explains a valid medical reason or valid preference reason (YES branch from block 1555) future flagging (e.g., suppression) of this particular recommendation can be entered into the report analysis system (block 1558) because this particular item purchase should not be deemed non-compliant/non-optimal. Finally, when the reported reason code indicates “in stock not purchased” (block 1560), the purchasing entity 140 has admitted that the recommendation should be adopted and presumably takes steps necessary to alter future purchasing practices for the corresponding item purchased (block 1565).

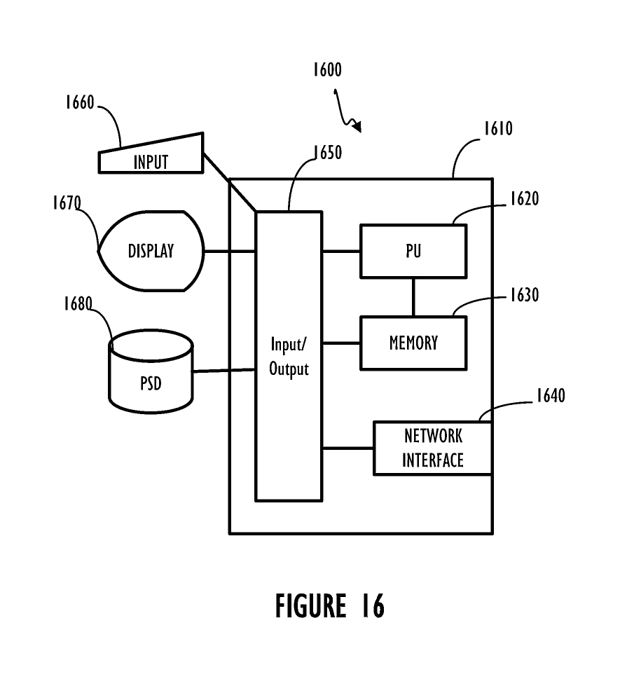

Referring now to FIG. 16, example computing device 1600 is shown. One or more example computing devices 1600 may be included in a mainframe or distributed computer (neither shown). Example computing device 1600 comprises a programmable control device 1610 which may be optionally connected to input devices 1660 (e.g., keyboard, mouse, touch screen, etc.), display 1670 and/or program storage device (PSD) 1680 (sometimes referred to as a direct access storage device DASD). Also, included with program control device 1610 is network interface 1640 for communication via a network with other computing and corporate infrastructure devices (not shown). Note network interface 1640 may be included within programmable control device 1610 or be external to programmable control device 1610. In either case, programmable control device 1610 will be communicatively coupled to network interface 1640. Also note, program storage unit 1680 represents any form of non-volatile storage including, but not limited to, all forms of optical and magnetic storage elements including solid-state storage.

Program control device 1610 may be included in a computing device and be programmed to perform methods in accordance with this disclosure. Program control device 1610 may itself comprise processing unit (PU) 1620, input-output (I/O) interface 1650 and memory 1630. Processing unit 1620 may include any programmable control device including, for example, processors of an IBM mainframe (such as a quad-core z10 mainframe microprocessor). Alternatively, in non-mainframe systems examples of processing unit 1620 include the Intel Core®, Pentium® and Celeron® processor families from Intel and the Cortex and ARM processor families from ARM. (INTEL CORE, PENTIUM and CELERON are registered trademarks of the Intel Corporation. CORTEX is a registered trademark of the ARM Limited Corporation. ARM is a registered trademark of the ARM Limited Company.) Memory 1630 may include one or more memory modules and comprise random access memory (RAM), read only memory (ROM), programmable read only memory (PROM), programmable read-write memory, and solid state memory. One of ordinary skill in the art will also recognize that PU 1620 may also include some internal memory including, for example, cache memory.

Aspects of the embodiments are described as a method of control or manipulation of data, and may be implemented in one or a combination of hardware, firmware, and software. Embodiments may also be implemented as instructions stored on a machine-readable medium, which may be read and executed by at least one processor to perform the operations described herein. A machine-readable medium may include any mechanism for tangibly embodying information in a form readable by a machine (e.g., a computer). For example, a machine-readable medium (sometimes referred to as a program storage device or a computer readable medium) may include read-only memory (ROM), random-access memory (RAM), magnetic disc storage media, optical storage media, flash-memory devices, electrical, optical, and others.

In the above detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim.

Various changes in the details of the illustrated operational methods are possible without departing from the scope of the following claims. For instance, illustrative flow chart steps or process steps of FIGS. 2A-B and 15 may be performed in an order different from that disclosed here. Alternatively, some embodiments may combine the activities described herein as being separate steps. Similarly, one or more of the described steps may be omitted, depending upon the specific operational environment the method is being implemented in. In addition, acts in accordance with FIGS. 2A-B and 15 may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”).

What is claimed is:

1. A method of generating a periodic purchase report outlining non-compliant or non-optimal purchases using a computer system comprising one or more processors, the method comprising:
obtaining contract information pertaining to pricing available to a purchasing entity, as made available through a contract portfolio;
obtaining purchase history information comprising purchases made by the purchasing entity, the purchase history information comprising information pertaining to analysis of previous non-compliant or non-optimal purchases;
analyzing, on the one or more processors, the purchase history information versus alternative purchasing possibilities defined in the contract portfolio;
identifying instances where a different purchase choice could have resulted in a lower cost for the purchasing entity, wherein the identifying of instances is based, in part, on the purchase history information; and
collecting the identified cases into a report for presentation to the purchasing entity.

2. The method of claim 1, wherein analyzing the purchase history information comprises using normalized data keyed by a unique product identifier.

3. The method of claim 2 wherein the unique product identifier is selected from the group consisting of barcode number, national drug code (NDC), universal product code (UPC), stock number, catalog item number and product item number.

4. The method of claim 1, wherein identifying cases comprises identifying an alternative packaging option for a substantially similar item purchase.

5. The method of claim 1, wherein the purchasing entity is selected from the group consisting of: a hospital, a group of hospitals, a hospital pharmacy, a retail or ambulatory pharmacy, and a long term care pharmacy.

6. The method of claim 1, further comprising transmitting information pertaining to at least a portion of the collected identified cases to a distributor servicing the purchasing entity.

7. The method of claim 6, wherein the information pertaining to at least a portion of the collected identified cases comprises information describing automatic substitution for future purchases.

8. The method of claim 1, wherein identifying cases comprises identifying a generically equivalent drug.

9. The method of claim 1, wherein identifying cases comprises identifying a therapeutically equivalent drug.

10. The method of claim 1, wherein identifying cases comprises identifying an alternative purchase with a different dosage form or route of administration.

11. The method of claim 10, wherein the different dosage form is selected from the group consisting of tablet, capsule, oral liquid, and suppository.

12. The method of claim 10, wherein the different route of administration is selected from the group consisting of oral, topical, and injectable.

13. The method of claim 1, wherein the report comprises feedback fields for the purchasing entity to comment on non-compliant or non-optimal purchases identified in the report.

14. The method of claim 1, further comprising presenting the report for presentation to the purchasing entity via email.

15. The method of claim 1, further comprising presenting the report for presentation to the purchasing entity via one or more web pages.

16. A computer network comprising:
a plurality of processing units communicatively coupled to a computer network; and
a first processing unit configured to perform at least a portion of the method of claim 1 wherein the entire method of claim 1 is performed collectively by the plurality of processing units.

17. A non-transitory computer readable storage medium comprising instructions stored thereon that when executed by one or more processors cause the one or more processors to perform a method of generating a periodic purchase report outlining non-compliant or non-optimal purchases wherein the one or more processors are configured to:
obtain contract information pertaining to pricing available to a purchasing entity, as made available through a contract portfolio;
obtain purchase history information comprising purchases made by the purchasing entity, the purchase history information comprising information pertaining to analysis of previous non-compliant or non-optimal purchases;
analyze the purchase history information versus alternative purchasing possibilities defined in the contract portfolio;
identify instances where a different purchase choice could have resulted in a lower cost for the purchasing entity, wherein the identifying of instances is based, in part, on the purchase history information; and
collect the identified cases into a report.

18. The non-transitory computer readable storage medium of claim 17, wherein the instructions to cause the one or more processors to identify cases comprise instructions to cause the one or more processors to identify an alternative packaging option for a substantially similar item purchase.

19. The non-transitory computer readable storage medium of claim 17, further comprising instructions to cause the one or more processors to transmit information pertaining to at least a portion of the collected identified cases to a distributor servicing the purchasing entity.

20. The non-transitory computer readable storage medium of claim 19, wherein the information pertaining to at least a portion of the collected identified cases comprises information describing automatic substitution for future purchases.
